(19) United States
(12) Patent Application Publication
(10) Pub. No.: US 2013/0097194 A1
(43) Pub. Date: Apr. 18, 2013

(54) APPARATUS, METHOD, AND COMPUTER-ACCESSIBLE MEDIUM FOR DISPLAYING VISUAL INFORMATION

(71) Applicants: OTAVIO BRAGA, New York, NY (US); Davi Geiger, New York, NY (US)

(72) Inventors: OTAVIO BRAGA, New York, NY (US); Davi Geiger, New York, NY (US)

(73) Assignee: New York University, New York, NY (US)

(21) Appl. No.: 13/567,634

(22) Filed: Aug. 6, 2012

Related U.S. Application Data
(60) Provisional application No. 61/515,649, filed on Aug. 5, 2011.

(51) Int. Cl. G06F 17/30

(52) U.S. Cl. CPC G06F 17/30256
USPC 707/758

(57) ABSTRACT

A method for displaying visual information corresponding to at least one user can including receiving a selection of at least one attribute to be viewed, with a computer arrangement, tracking at least one user pose of the at least one user in real-time using a marker-less capture procedure to generate tracking information, matching the at least one user pose with at least one database pose provided in a database based on the tracking information, and displaying the at least one database pose in combination with the at least one attribute.

### CROSS-REFERENCE TO RELATED APPLICATION(S)

This application claims priority to U.S. Provisional Application No. 61/515,649 filed on Aug. 5, 2011. The entire disclosure of the above-referenced application is incorporated herein by reference in its entirety.

### FIELD OF THE DISCLOSURE

The present disclosure relates generally to system, method and computer accessible medium for providing image or video of a user changing their clothing or other attributes, and more specifically, to exemplary embodiments of system, method and computer accessible medium that facilitates a user to select different clothing, accessories or other attributes from a database, and to provide that user with an image or a video showing a person wearing the clothing, accessories, or other attributes.

### BACKGROUND INFORMATION

Determining which outfit to wear on a daily basis can be very time consuming. A person must first select the potential outfits to wear, and then try on all of the different outfits, including mixing and matching different parts of different outfits in order to choose the best combination. This process needs to be repeated every day, and it can also be time consuming to select clothes to purchase at a store. First, the user must browse the entire store, and select the items the user wishes to try on. Then, the user enters a changing room, and tries on all of the clothing. In order to alleviate the time and stress of this process, different systems have been developed. Many fashion retail websites, such as Glamour magazine, H&M's retail website's “Virtual Dressing Room”, and other companies such as Embodee's online try-on developed applets in an attempt to address the above described issues. For example, JC Penny's, in collaboration with Seventeen Magazine's website, utilizes an augmented reality, a camera, and a web-browser having Flash plug-in. These systems can use rudimentary face and body tracking, in combination with pre-rendered still images, to show the user wearing the clothing. However, such systems do not use real-time video for illustrating the clothing appearance changes.

Other full-body techniques typically employ graph-based structures derived from large motion-capture data. (See, e.g., ARIKAN, O., AND FORSYTH, D., “Interactive motion generation from examples”, ACM Transactions on Graphics 21, 3, 483-490, 2002; KOVAR, L., GLEICHER, M., AND PIGHIN, F., “Motion graphs”, ACM Transactions on Graphics (TOG) 21, 3, 473-482, 2002; LEE, J., CHAI, J., REITSMA, P., HODGINS, 311 J., AND POLLARD, N., “Interactive control of avatars animated with human motion data”, ACM Transactions on Graphics 21, 3, 491-500, 2002; LI, Y., WANG, T., AND SHUM, H., “Motion texture: a two level statistical model for character motion synthesis”, In Proceedings of the 29th annual conference on Computer graphics and interactive techniques, ACM, 465-472, 2002; PULLEN, K., AND BREGLER, C., “Motion capture assisted animation: texturing and synthesis”, ACM Transactions on Graphics (SIGGRAPH 2002) 21, 3, 501-508, 2002). However, there is no video used in these techniques. Other related technologies can include more general video based techniques, such as, Video Sprites (see, e.g., SCHODL, A., AND ESSA, I., “Controlled animation of video sprites”, In Proceedings of the 2002 ACM SIGGRAPH/Eurographics symposium on Computer animation, ACM, 121-127, 2002) and Human Video Textures (see, e.g., FLAGG, M., NAKAZAWA, A., ZHANG, Q., KANG, S., RYU, Y., ESSA, I., AND REHG, J., “Human video textures”, In Proceedings of the 2009 symposium on Interactive 3D graphics and games, ACM, 199-206, 2009). In such cases, either matting-based extraction is used without explicit skeletal annotation, or a marker-based system in parallel to HD video acquisition is utilized. However, no real-time video input is used to drive the animations. Three-dimensional (“3D”) extensions of video based acquisition techniques have been recently advanced. (See, e.g., DE AGUIAR, E., STOLL, C., THEOBALT, C., AHMED, N., SEIDEL, H., AND THRUN, S., “Performance capture from sparse multi-view video”, In ACM Transactions on Graphics (TOG), vol. 27, ACM, 98, 2008; DENG, Z., AND NOH, J., “Computer facial animation: A survey. Data-Driven 3D Facial Animation”, pp. 1-28, 2007). Further, a dynamic simulation based cloth modeling has been incorporated into these 3D video based capture techniques. (See, e.g., STOLL, C., GALL, J., DE AGUIAR, E., THRUN, S., AND THEOBALT, C., “Video-based reconstruction of animatable human characters”, In ACM Transactions on Graphics (TOG), vol. 29, ACM, 139, 2010). None of the above, however, provides a user with real-time tracking to display what the clothing would look like to the user.

Thus, it may be beneficial to provide exemplary system, method and computer accessible medium for the real-time video display of a person wearing different clothing that can be easily manipulated and controlled by a user, and which can address and/or overcome at least some of the deficiencies described herein above.

### SUMMARY OF EXEMPLARY EMBODIMENTS

Thus, to address and/or overcome at least some of the issues described herein above, exemplary embodiments of the system, method and computer accessible medium, called BodySwap or BodyJam can be provided which can facilitate a user to change his/her outfit quickly. For example, the exemplary system, method and computer accessible medium can facilitate a real-time full body view of a user and display poses, in real-time, of a person standing in front of the camera/display mirror, facilitating the user to change his/her clothes as well as other appearance attributes. According to certain exemplary embodiments of the present disclosure, procedures can be provided for real-time video based rendering system. For example, BodySwap can be used, e.g., as a virtual mirror to dress and re-dress people in different clothing. In certain exemplary embodiments of BodySwap, a specific garment can be changed, a different person can be provided, and/or a specific garment can be controlled.

The exemplary system, method and computer accessible medium can take advantage of marker-less skeletal tracking techniques, such as, e.g., Microsoft's Kinect. (See, e.g., Reference 16). Unlike conventional systems which are example-based rendering systems that need marker based data, according to the particular exemplary embodiments of the present disclosure, a marker-less annotation can be used for the input video that can be driving the animation, and marker-less annotation for the video-based render database. The exemplary system, method and computer accessible medium can include engines to learn from face and body retargeting and re-writing systems, such as, e.g., those described in References 2, 3, 6, and 18, that use computer vision to annotate or drive facial animation. For example, Reference 19 describes a Kinect-based real-time facial retargeting system.

According to additional exemplary embodiment of the present disclosure, poses can be matched to a video database of different torsos and legs. “Pages” can be turned by gestures interpreted through the video tracking. Some or all body poses can be mirrored in real time, and outfits can be mixed and matched through gestures and poses by the user

The exemplary applications of such technologies can be immense including: video games, movies, fashion retail stores, to name a few areas.

These and other objects of the present disclosure can be achieved by provisions of exemplary systems, methods and computer-accessible mediums according to exemplary embodiments of the present disclosure for displaying visual information corresponding to at least one user, using which a selection of at least one attribute to be viewed can be received, at least one user pose of the at least one user in real-time can be tracked using a marker-less capture procedure. The user pose(s) can be matched with at least one database pose in a database, and the database pose(s) can be displayed in combination with the attribute(s).

In particular exemplary embodiments of the present disclosure, the database can include a plurality of stored images of previously captured skeletal annotated poses captured using a marker-less capture procedure. The previously captured skeletal annotated poses can be of at least one person presenting different attributes. According to some exemplary embodiments, the attributes can include clothing and/or accessory. In particular exemplary embodiments, a skin color of the user/person analyzed can be modified to match the skin color of the user. The database pose(s) can approximately match position and/or orientation of the user pose(s).

According to further exemplary embodiments of the present disclosure, clothing can be conformed to a body of the user(s) by analyzing the body style of the user. For example, the tracking of user(s) can be performed using a camera. The marker-less capture procedure can be performed using an OpenNI Framework. At least one further user pose can be tracked and matched to at least one further database pose, and the further database pose(s) can be displayed. In some exemplary embodiments of the present disclosure, the matching procedures can be performed by searching the database for poses that are close to the at least one first database pose. For example, the database can be searched using a nearest neighbor algorithm.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is a set of exemplary images with a plurality of poses of a user overlaid by the projected skeleton provided in an exemplary database according to an exemplary embodiment of the present disclosure;

FIG. 2 is a set of further exemplary images of the user with a change in skin color to match the skin color of the user according to an exemplary embodiment of the present disclosure;

FIG. 3 is a set of exemplary faces provided in the exemplary database according to an exemplary embodiment of the present disclosure;

FIG. 4 is a flow chart illustrating a method for recording poses in a pose database according to an exemplary embodiment of the present application;

FIG. 5 is exemplary application and results of a system utilizing a “BodySwap” procedure according to an exemplary embodiment of the present disclosure;

FIG. 6 is a flow chart illustrating the exemplary BodySwap procedure according to an exemplary embodiment of the present application;

FIG. 7 is an exemplary application of a real-time control of a selected outfit composed of clothes from two separate databases using the exemplary system, method and/or computer-accessible medium according to an exemplary embodiment of the present disclosure;

FIG. 8 is a flow chart illustrating a procedure implementing an exemplary skin color modification according to an exemplary embodiment of the present application;

FIG. 9 is exemplary use and/or application of exemplary hand gestures which facilitates the user to flip through different combinations of outfits according to an exemplary embodiment of the present disclosure;

FIG. 10 is a set of exemplary images poses provided in an exemplary pose database according to an exemplary embodiment of the present disclosure;

FIG. 11 is a set of images illustrating the real-time tracking of the user and the corresponding real-time animation of a person wearing the clothing according to an exemplary embodiment of the present disclosure;

FIG. 12 is an exemplary hand tracking interface according to an exemplary embodiment of the present disclosure; and

FIG. 13 is an exemplary block diagram of an exemplary system in accordance with certain exemplary embodiments of the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures.

### DETAILED DESCRIPTION OF EXEMPLARY EMBODIMENTS

The exemplary embodiments of the present disclosure may be further understood with reference to the following description and the related appended drawings. The exemplary embodiments of the present disclosure relate to camera tracking system, method and computer-accessible medium, associated database for the real-time tracking, and a display of a person wearing different clothing. Specifically, the exemplary system, method and computer-accessible medium can track a user's movement and display a person moving in a similar manner wearing the desired clothing. The exemplary embodiments are described with reference to a person wearing clothing, although those having ordinary skill in the art will understand that the exemplary embodiments of the present disclosure may be implemented on any real-time tracking system that can display a person moving in a similar manner to the user.

Exemplary Generation of Clothing Database

According to exemplary embodiments of the present disclosure, a clothing database can be generated. For example, using a video detection system (See, e.g., SHOTTON J., FITZGIBBON A., COOK M., SHARP T., FINOCCHIO M., MOORE R., KIPMAN A., BLAKE A., “Realtime human pose recognition in parts from a single depth image”), the performance of one person (e.g., the model) wearing a piece of clothing can be recorded, and a database of the clothing's appearances from multiple poses can be created. To generate the image database for a piece of clothing, an exemplary model can be dressed with the clothing and a performance of him or her moving around can be recorded, annotated by his/her 3D skeleton. This can be accomplished using a video camera and depth extraction (e.g., like a mocap system combined with a video camera). In an exemplary embodiment of the present disclosure, a Kinect sensor can be used to capture the performance with the skeleton being computed by the OpenNI Framework (see, e.g., OPENNI. OpenNI. www.openni.org). For each frame of the performance, a database entry can be created containing the video frame image and the corresponding skeleton for the model's pose. For example, for each frame of the performance captured at a constant frame rate, a database entry containing the video frame image and the corresponding skeleton for the model's pose can be generated.

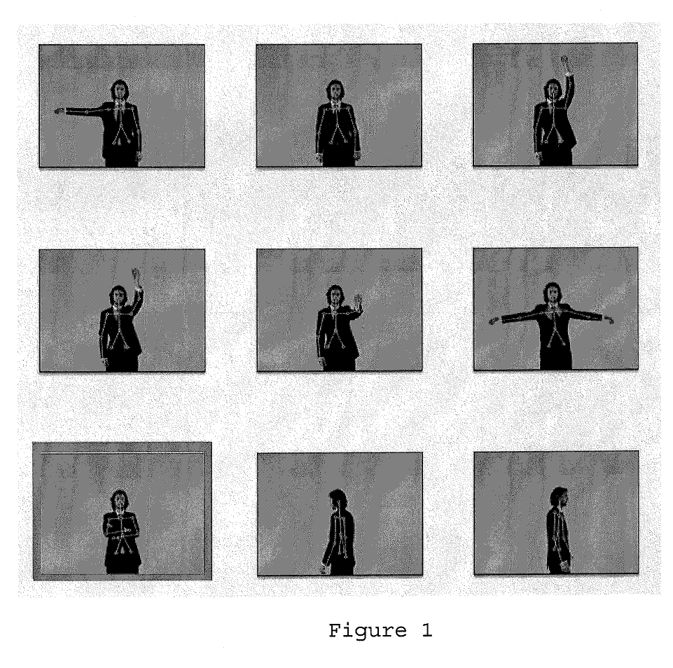

To establish a notation, an image database D={E_{f}} can be a set of pairs E_{f}=(S_{f}, I_{f}) composed of a 3D skeleton S_{f} and an image I_{f} extracted from the video of the performance. The video frame number can be f. The skeleton S_{f}={J_{f,j} j=1, . . . , n} in turn, can be composed of the n 3D joint positions J_{f,j} for each frame f. FIG. 1 illustrates a set of exemplary images with a plurality of poses of a user overlaid by the projected skeleton provided an exemplary database, in which a few frames from the video of a performance model dressed in a suit are shown. The whole exemplary performance, which can last around, e.g., 45 seconds, can then be cropped in time to its usable parts. The video can be delayed, for example, by a couple of frames when generating and/or updating the database in order to compensate for the delay in the skeleton computation. The resulting exemplary image database, having, e.g., about 1200 entries, can then be used, for example, for the real-time control.

According to certain exemplary embodiments of the present disclosure, poses can be captured using the distance between the joint orientations quaternions, which are insensitive to the skeleton's bone sizes.

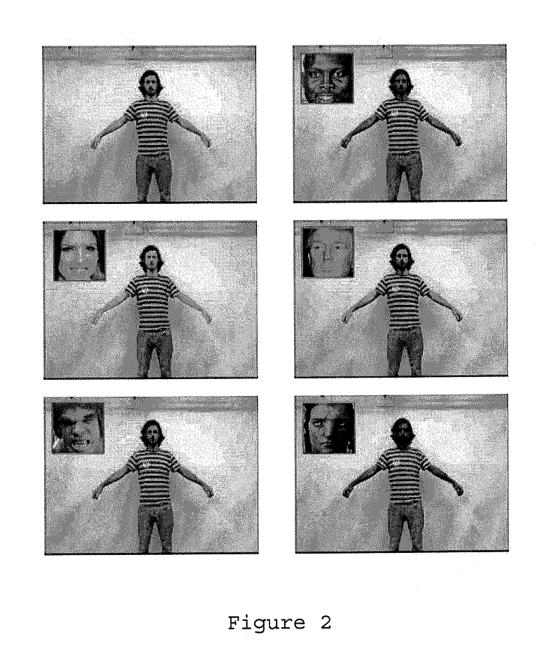

According to certain exemplary embodiments of the present disclosure, the performances of the reference model wearing various styles and colors of clothes can be recorded. Each performance can give rise to a separate image database capturing the clothing's appearances from multiple poses. Some exemplary databases can be marked, for example, as being suitable exclusively for the upper body, others, just for the lower body, while some can be used for both. The exemplary databases can then be revised and/or generated, for example, as a clothing library. FIG. 2 illustrates is a set of further exemplary images of the user provided in an exemplary database library by indicating a selection of its databases with clothes that can be used as top or bottom from different poses.

According to certain exemplary embodiments of the present disclosure, the exemplary database can be indexed frame-by-frame. The exemplary database can be made of small video clips, video clips of size ˜½ second (e.g., about 12 frames per video clip). Other manipulations can be performed used or based on information contained in the database which can save search time (e.g., since at each search a video clip, e.g., 12 frames) and can create smoother sensations during playback.

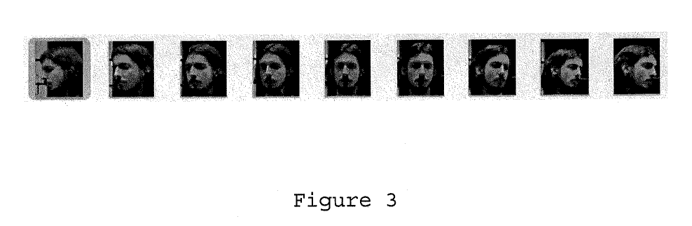

According to certain exemplary embodiments of the present disclosure, a face database can be generated. As skeleton information may not be present or needed, the pose of the face can be extracted from the detection of the left and right eyes. The pose can be the information that replaces the joints of the skeleton for a body (see e.g., FIG. 3).

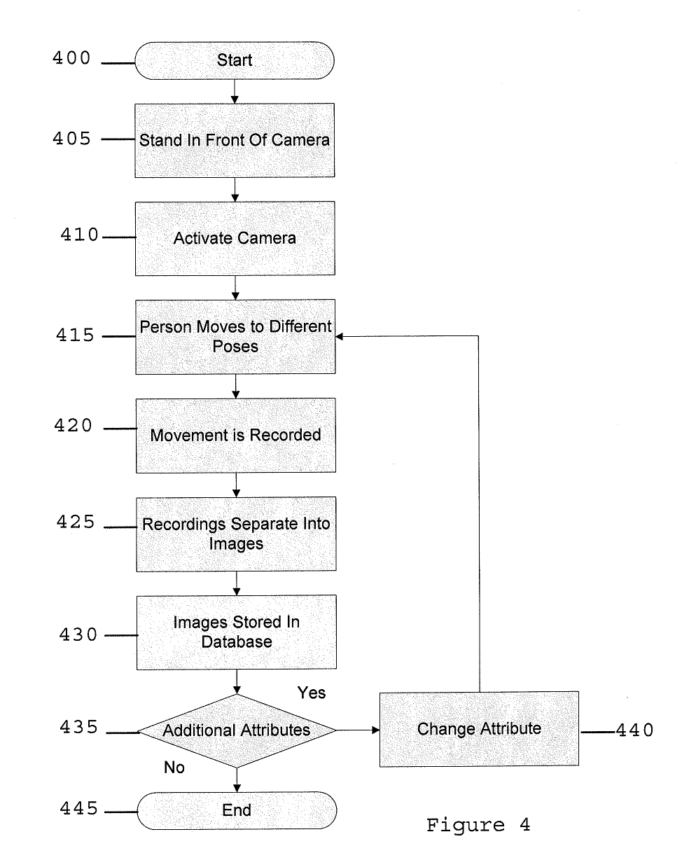

Referring to FIG. 4, a flow-chart is provided illustrating an exemplary method for recording of images into a pose database. In particular, at procedure 400, the exemplary method of capturing the poses is initiated. At procedure 405, a person who is modeling the attribute stands in front of a camera or another image capturing device so that the image(s) can be recorded. At procedure 410, the image recording device can be activated to record the image of the person. Any suitable recording, including marker-less recording, can be used. At procedure 415, the person moves around and can strike different poses. For example, the person may have their arms at their side, their arms extending, their arms above their head, although not limited thereto. The user can also turn in different directions such that different viewing angles of the person and the attribute can be recorded. While the person strikes different poses and performs different movements, the movement can be recorded by the image recording device at procedure 420. Once all of the movements have been recorded, the recorded video can be separated into different images at procedure 425. By splitting the video into small images, a fluid transition can be created when showing the poses to a user of the exemplary system, method and computer-accessible medium. At procedure 430, the images can be stored in a database such as a pose database. Other databases can be created depending on the information captured such as a face database. After the images are stored in the database, additional attributes can be recorded at procedure 435. If additional attributes are desired, the attribute can be changed at procedure 440, and the exemplary method can be repeated. If no additional attributes are desired, the method ends at procedure 445. While the above-described exemplary procedure shows a sequence of procedures, different sequences can be used such as the additional attributes can be recorded prior to the video being separated out into individual images at procedure 425.

Exemplary Body Swapping

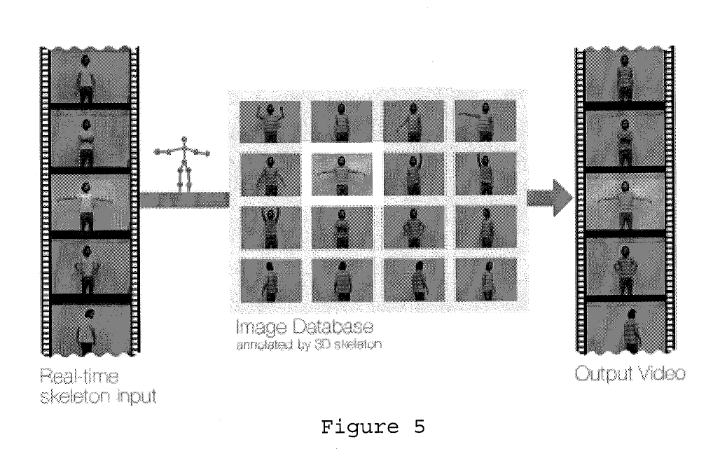

Referring to FIG. 5, with an exemplary database D generated from a previous recording at a later time, a second person (e.g., the controller) can control, in real-time, the performance of the model stored in the database. For example, a user can select a particular attribute he/she wish to view including clothing type (e.g., pajamas, athletic wear, swimwear etc.), clothing style (e.g., casual, dressy, business etc.), clothing color, etc. Users can also select an attribute corresponding to an accessory (e.g., jewelry, ties, sunglasses, hats etc.). Additional attributes may be recorded to be selected by the user.

To control the exemplary system, method and computer accessible medium, the controller's skeleton S(t), as well as a position and orientation of the user, can be tracked, for example, in real-time, at moments t, to query the database for the frame that best matches his or her current pose. Initially, the entry E_{f}=(S_{f}, I_{f}) containing the best matching skeleton can be sought. At each moment t, the controller's skeleton S(t) can be used to search in a database D for the entry with the pose, which can include a position and orientation, that best matches his or her pose:

$${f}^{*} = {argmin}_{f} d ( {S}_{f} , S ( t ) ) , \qquad ( 1 )$$

where d can be a skeleton distance function, and then image I_{f(t)} can be displayed on the screen back to the controller, giving him/her the impression that the model is mimicking his/her performance. For notation simplicity, the index t can be omitted sometimes from f(t). E_{f}=₍S_{f}, I_{f)} as the database entry corresponding to the best matching skeleton S_{f} (e.g., at time t). Next, I_{f} can be displayed on the screen giving the controller the impression of a virtual mirror.

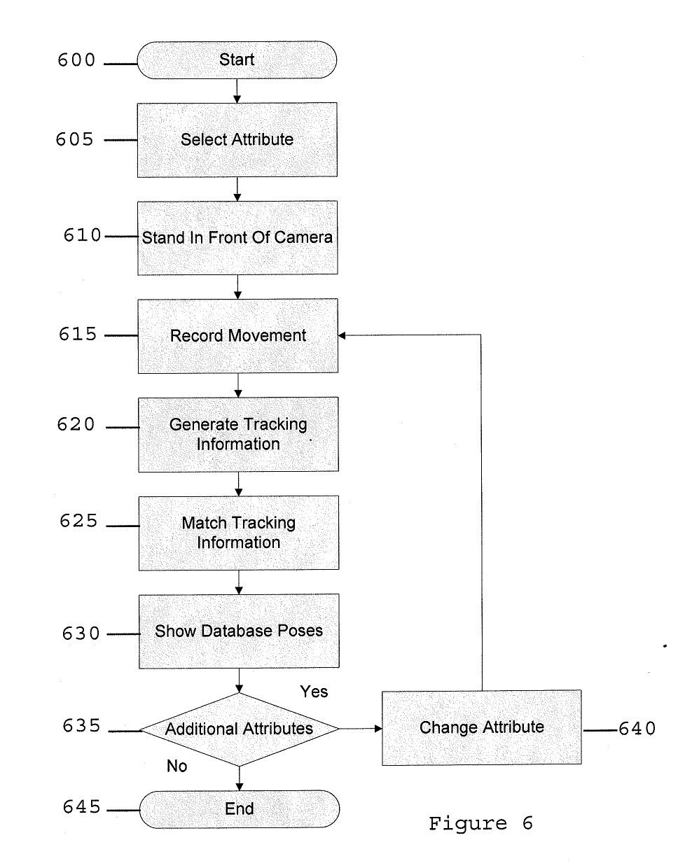

FIG. 6 shows a flow-chart illustrating of a BodySwap process according to an exemplary embodiment of the present disclosure is shown. For example, at procedure 600, the exemplary process starts with a user deciding to employ the exemplary system, method and computer-accessible medium. At procedure 605, the user selects an attribute. The attribute can be clothing or an accessory, as well as styles and colors of clothing and accessories, although not limited thereto. At procedure 610, the user stands in front of the camera or any other image capturing device, and the user's movement is recorded at procedure 615. At procedure 620, tracking information based on the user's movement is generated, and is compared and matched to tracking information stored in a database at procedure 625. After the tracking information has been matched, at procedure 630 the poses from the database are displayed to the user. At procedure 635, the user has the option to change the attribute at 640 and repeat the method, or the user can end the method at procedure 645.

Exemplary Distance Function: For the skeleton distance function d used to search the image database, a weighted sum of squared distances between the 3D joints of the two skeletons can be used. Moreover, in order to make the control insensitive to translations, the skeletons can first be centered by their torso's joint (e.g., the model can be instructed to roughly move in place when recording the performance for the image database). More precisely, the distance between skeletons S={Jⱼ; j=1, . . . , n} and S′={J′ⱼ; j=1, . . . , n} is to be computed. For example, such skeletons can come already ordered by their type of junction, so the correspondence between joints can already be provided, e.g., by the Kinect. Their joints can first be centered around the respective torsos J_{T} and J′_{T}, obtaining, for example, new, translated skeletons:

\tilde{S}=(\tilde{J}ᵢ; i=1, . . . , n)=(Jᵢ−J_{T}; i=1, . . . , n),

\tilde{S}′=(\tilde{J}′ᵢ; i=1, . . . , n)=(J′ᵢ−J′_{T}; i=1, . . . , n).

The distance can then be determined as:

$$d ( S , {S}^{′} ) = d ( \tilde{S} , {\tilde{S}}^{′} ) = {\sum }_{i = 1}^{n} {w}_{i} {‖ {\tilde{J}}_{i} - {\tilde{J}}_{i}^{′} ‖}^{2} , \qquad ( 2 )$$

where the weights Wⱼ can be used to improve the playback smoothness (e.g., joints on the torso typically have higher weights than the limbs), as well as to eliminate some of the joints from being controlling altogether. For example, if there is interest only in moving the upper body, the weights of the leg joints can be set to zero. Further, the joint velocities can be incorporated in addition to the positions, which can be a simple matter of extending the database with more annotations. The velocities can facilitate resolving conflicts between nearby poses (e.g., an arm moving up versus moving down).

Exemplary Nearest Neighbor Search: For each query, it can be preferable to search through the database for the entry which holds the skeleton closest to the controller's current pose. According to certain exemplary embodiments of the present disclosure, a straight linear search can be used. Alternatively, more sophisticated nearest neighbor search algorithms, such as space partitioning approaches can be used. In large databases, an efficient search algorithm can be preferable.

Exemplary “Hysteresis” Thresholding for Smoothness: In order to remove jittering and compute in real-time playback, nearby video frames that are in consecutive queries can be used for as long as the skeleton distance stays within a threshold. For example, if the query at one moment t returned the database entry E_{f*}=(S_{f*}, I_{f*}). For the next query, at time t+1, instead of searching the whole database, as in equation (1), candidates can be limited to entries inside a window of width W around frame f at time t. For example, equation (1) can be described by the following pseudo program, e.g.:

$${f}^{*} ( t + 1 ) = {argmin}_{{f}_{\vert f - {f}^{*} ( t ) \vert \leq w}} d ( {S}_{f} , S ( t + 1 ) ) , \\ if ( d ( {S}_{ftemp} S ( t + 1 ) > T ) \\ {f}_{temp} = {argmin}_{f} d ( {S}_{f} , S ( t + 1 ) ) \\ end \\ {f}^{*} ( t + 1 ) = {f}_{temp} \qquad ( 3 )$$

where S(t+1) can be the controller's skeleton, and f*(t+1) can be the frame number displayed next. T can be a threshold parameter. In certain exemplary embodiments, W can equal 4. When the distance of the local optimum computed with the first equation in (eq. 3) becomes too large (e.g., according to parameter T), a long transition can be provided by resorting back to searching the closest matching skeleton over the database using, for example, the second equation in (eq. 3). This can remove jittering because, when the original model moved around, he or she may have passed multiple times through nearby poses, which can become a source of jittering in the real-time playback. By using adjacent frames, the system can use smoother video sequences present in the original recording.

Exemplary Image Buffering: The exemplary images can be obtained, for example, from disk to main memory on demand when performing database queries. As an option to limit memory consumption in the case of large databases, a memory budget can be assigned on how many images can be allowed to be in memory at one given time. Then, a LRU cache replacement policy can be employed by, when necessary, first swapping back to disk the frames with the oldest access time. Moreover, a simple predictive caching scheme can be used, e.g., by pre-loading into main memory a window of frames around the frame returned by a query.

Exemplary Frame Discarding: The exemplary system can be organized around two threads: the image database matching thread, which can produce the best matching frame based on the controller's real time skeleton, and the rendering thread, which can display the matched frames on the screen. The matching thread can add frames to a queue, annotated with a timestamp of the query, and the rendering thread consumes frames from the queue. In order to avoid occasional long lags between the controller's movement and the video that is displayed back to him/her, maintaining the feel of real-time control, the rendering thread can discard the frames that are too old when dequeing a new frame for display.

Exemplary Skin Color Swapping

In order for the user to better identify himself/herself with the body that is being shown on the screen, the user's skin color can be transferred to the model that was originally used to create the database. The images can be modified from the databases at runtime using a statistical model of the color distribution on both skin regions. A transformation that gives convincing results can be accomplished as well as one that runs fast enough to be computed immediately in real-time after a new user steps in without disrupting the experience.

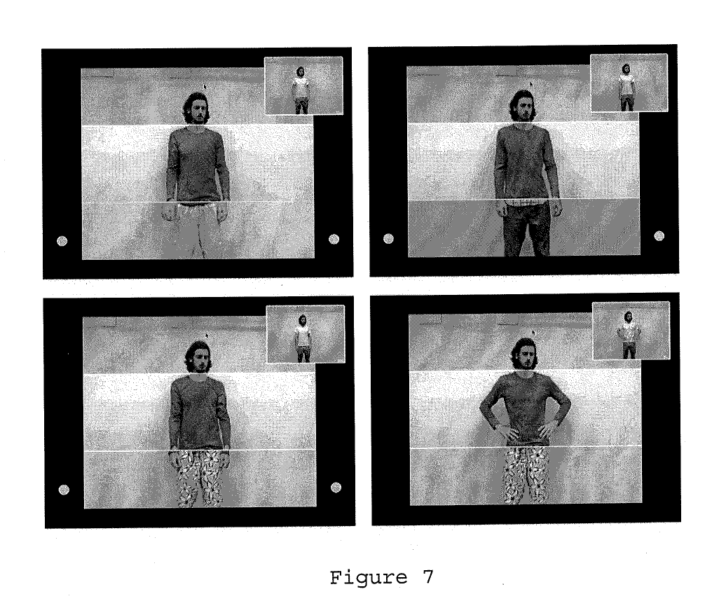

FIG. 7 shows exemplary frames of the skin color transfer applied to transfer various skin tones to an image from one of the clothing databases.

Skin Color Transfer: Images can be transformed from RGB space into 1αβ space (see e.g., Reference 25). The details of the transformation from RGB to 1αβ space can be found in Reference 23. In the discussion that follows, the color is assumed to be represented in 1αβ space. The skin color distribution of the target image ct is modeled as a Gaussian:

cₜ˜ [symbol] (cₜ;μₜ,Σₜ) (4)

and the color distribution in the source image c, as a mixture of Gaussians:

$${c}_{s} ∼ {\sum }_{i = 1}^{n} {π}_{i} 𝒩 ( {c}_{s} ; {μ}_{i} , {\sum }_{i} ) \qquad ( 5 )$$

using the EM algorithm (see e.g., Reference 5). Two components for the Gaussian mixture of the face can be used (i.e., n=2), which can be enough to model in one component the actual skin pixels and, in the other, pixels not corresponding to skin, such as eyes and hair pixels. A Gaussian distribution responsible for the greater number of pixels to model the user's skin color distribution can be used. This can be denoted N (cs; μs; Σs).

Having N (cs; μs; Σs) and N (ct; μt; Σt) describing the skin color distributions in the source and target images, respectively. Each pixel is then transformed in the skin region of the target image by warping the distribution N (ct; μt; Σt) into N (cs; μs; Σs). More precisely, when Vt is the 3×3 matrix of eigenvectors of Et, with one eigenvector per column, and Dt a diagonal matrix holding the corresponding eigenvalues in the main diagonal. Define V, and D, the same way for E.

Each pixel ct in the target image is then transformed by:

$${c}_{t}^{′} = {D}_{s}^{\frac{1}{2}} {V}_{s} {D}_{t}^{- \frac{1}{2}} {V}_{t}^{T} ( {c}_{t} - {μ}_{t} ) + {μ}_{s} , \qquad ( 6 )$$

and then converted back to RGB space.

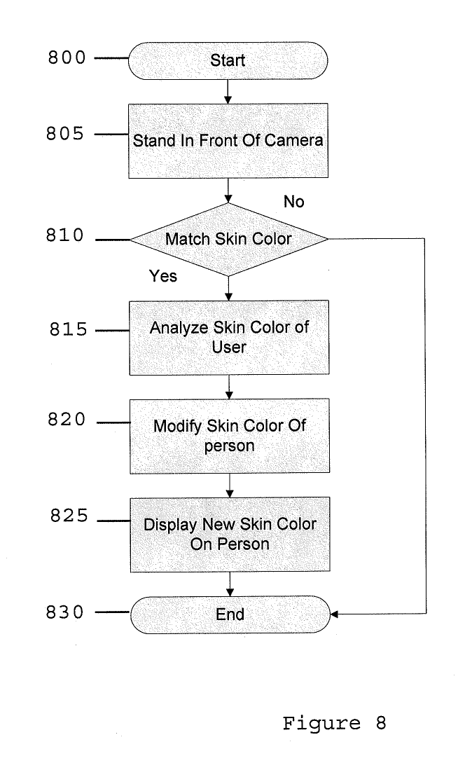

Referring to FIG. 8, a flow-chart illustrating an exemplary method which facilitates a modification of skin color is shown. At procedure 800, the method begins. The exemplary method can be incorporated into the exemplary BodySwap process, as shown in FIG. 6, to provide the user a more accurate view of what the user would look like having the selected attribute. At procedure 805, the user stands in front of the camera or any other image capturing device. At procedure 810, the user has the option to change the skin color of the person showing the attribute to match the user's skin color. If the user chooses not to change the skin color, then the method ends at procedure 830. If at procedure 810 the user decides to match their skin color, using information obtained from the image capturing device, the skin color can be analyzed at procedure 815. Once the skin color is analyzed, the skin color of the person showing the different attributes can be modified at procedure 820. The person showing the different attributes, e.g., having the new skin color, can be displayed at procedure 825 to give the user of the exemplary system, method and computer-accessible medium a more accurate representation of what the user would look like having the selected attributes. The method ends at procedure 830 at which point the user can interact with the exemplary system, method and computer-accessible medium as described above in FIG. 6.

Defining the Skin Masks: To capture the skin region in the source image, whenever a new user jumps in, a Viola-Jones face detector can be employed (See e.g., Reference 30 P. Viola and M. Jones. “Rapid object detection using a boosted cascade of simple features, In Computer Vision and Pattern Recognition, 2001. CVPR 2001. Proceedings of the 2001 IEEE Computer Society Conference on, volume 1, pp. I-511-I-518, vol. 1, 2010) to mask out the controller's face in the source image. The target skin region, on the other hand, can be computed offline, since it corresponds to images in the clothing database. The skin regions are masked by rotoscoping the database videos in Adobe After Effects using the Roto Brush tool, although not limited thereto. The exemplary result is that a skin area mask for each frame in the database can be stored along with the Gaussian describing the skin color distribution of the reference model that was used to record the garment (also computed offline).

At run-time, skin color transformation can be applied very fast, since all that is needed is to estimate the Gaussian mixture inside the user face region in a single frame, and then use the resulting model to compute transformation (see, e.g., eq. 6). To further increase speed, transformation (eq. 6) and the 1αβ⇄RGB color space conversions can be computed in a fragment program in the GPU whenever an image from the database is shown.

Exemplary Body Jam

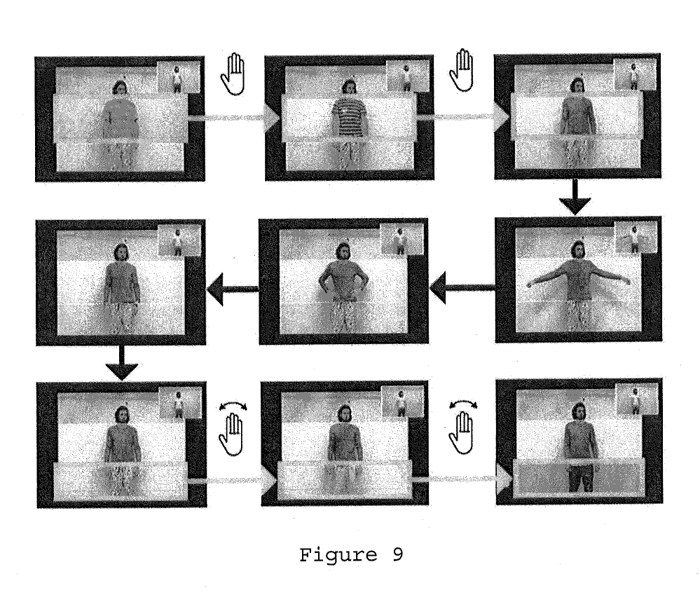

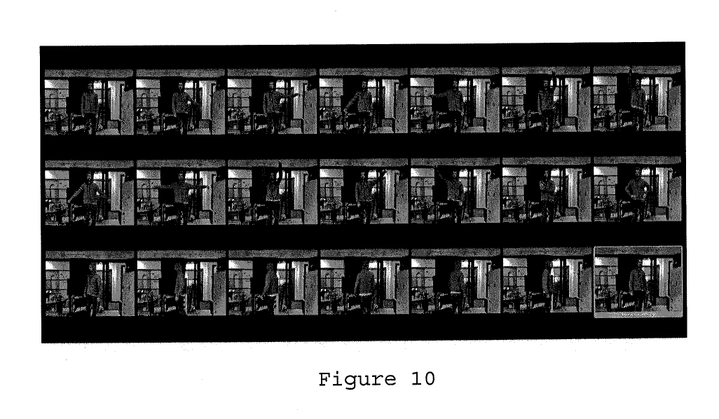

According to an exemplary implementation of exemplary embodiments of the present disclosure, Microsoft's Kinect procedure can be used. For example, as shown in FIG. 9, exemplary poses, such as poses in a pose database (see, e.g., FIG. 10) can be matched to a video database of different torsos and legs, and pages showing different clothes can be turned by hand gestures. The BodyJam process can employ the exemplary procedures used in Body Swap, which are described herein below.

According to another exemplary embodiment of the present disclosure, the user can move, for example, in front of a video sensor, and a screen can illustrate the user being dressed in different clothes. By using hand gestures, the user can independently flip through the clothes dressing their upper and lower body. With this interface, the user is able to for example, choose between different styles, patterns, colors, as well as to evaluate which garments go well together. Moreover, by making use of the techniques presented in Body Swap, users not only can see themselves in different clothes, but can also control, in real time, the animation of the body.

According to certain exemplary embodiments of the present disclosure, the electronic representations of the clothes can be manipulated so that the clothes are conformed to the body of the user. For example, the clothes stored in the database can be modeled by individuals having different body styles, for example, different body-shapes than the user (e.g., rounded shoulders compared to square shoulders; slight build compared to muscular build; etc.). Accordingly to certain exemplary embodiments of the present disclosure, procedures can be provided to manipulate the appearance of the clothing to conform the clothing to the body to provide a more realistic fit on the user.

Exemplary Controlling of Three Separate Body Parts

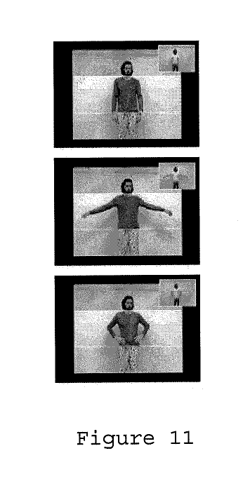

Overview of the Exemplary User interface (UI): The exemplary screen can be divided into three separate stacked layers (see, e.g., FIG. 11). For example, the upper layer can illustrate the real-time video of the controller's head, the middle layer can illustrate the piece of clothing currently selected for the upper body (e.g., shirts, jackets, etc.), and the bottom layer can illustrate the piece of clothing currently selected for the lower body (e.g., pants, skirts, etc.). An electronic library of pre-recorded clothing databases can be maintained, and, e.g., at each moment, at least one can be active for the upper body, and at least one can be active for the lower body. The middle and bottom layers can display the video outputs of these two concurrently running databases, which can be driven by the user's real time skeleton. Each of such videos, in addition to the cropped real time video of the user's head, can be texture mapped to its corresponding rectangle that is shown back to the user. FIG. 11 shows, for example, images of exemplary frames from a real-time performance. The whole skeleton extracted from Eq. 3, e.g., can be used even when driving the lower body database. This can have a beneficial effect of making the arms and hands “cross the boundaries” and show up in the lower layer consistently with the upper body. Even though the alignment may not be perfect, just seeing the arms crossing the video boundaries can add an appealing visual effect. Alternatively, one single bigger layer for the whole body instead of the two bottom ones (e.g., to show a dress, for instance) can be used.

Exemplary Aligning the Body Parts

In order to generate the final composition of the three stacked layers, the real-time video of the controller, e.g., the upper, and the lower body videos generated by the upper and lower body image databases, can be cropped, scaled and/or aligned.

Exemplary Cropping: The video frames retrieved from a database feeding the upper body video between the neck and waistline can be cropped. To accomplish this, the projection, for example, on the Kinect's image plane, of the 3D skeleton annotations contained in the result of a database query, can be used. When used for the lower body, the frames below the waist line can be cropped. The real-time video of the controller, in turn, can be cropped above the neck using the real-time tracked skeleton, for example, with the Kinect procedure.

Exemplary Alignment: The exemplary images can be aligned based on the projected skeletons. A projected skeleton can be the skeletons described by the joint information without the “z-component”. The “z-component” can be, for example, the component away from the Kinect, e.g., the one that describes depth away from the Kinect. The real-time head position can be aligned with the neck position contained in the entry from the upper body database, and the lower body or waist, in turn, can be aligned with the upper body.

Exemplary Scaling: In addition to the exemplary alignment, the videos can be appropriately scaled in order to generate a convincing final composition. Again, the projected joints can be employed. The lower body can be scaled in relation to the upper body based on the ratio of the projected torsos of each. The head can be scaled in relation to the torso based on the distance from the neck to the head.

Exemplary Changing Clothes

According to certain exemplary embodiments of the present disclosure, flipping through the clothes can be accomplished via various computer-based procedures.

Exemplary Gesture Driven Switch: When using hand gestures for control, at each moment the clothes of the upper or the lower body can be changed, indicated to the user by two small yellow circles aligned with the active layer (see, e.g., FIG. 7). For example, a “push” gesture (e.g., moving the hand forward, towards the camera, and back) can alternate between the two. Additionally, a hand waving gesture can change the piece of clothing of the active body part, accomplished, for example, by switching the image database associated with it. Again, OpenNI/NITE (See e.g., OPENNI. OpenNI. www.openni.org) can be used, for example, for gesture recognition.

Exemplary Timed Random Switch: As an alternative, a timed switch between clothes that randomly alternates between the databases available in the clothing library can be employed. It can be used offline to create avatars dressed in any clothes, or even to dress Hollywood actors to produce movies, without requiring them to ever try on the clothes.

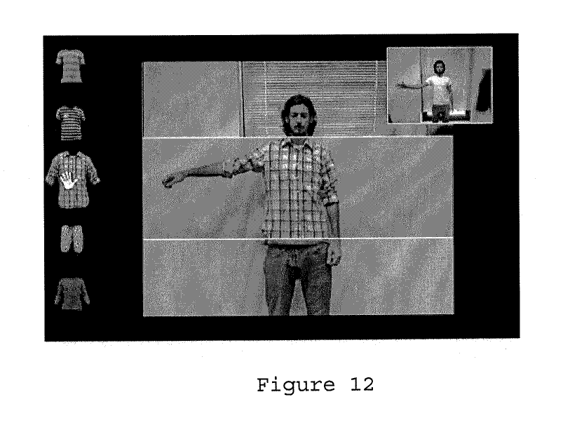

Exemplary Hand Tracking Interface: In a more realistic setting, users should be able to pick clothes from a catalog. Also, a “hand cursor” interface can be implemented where thumbnails of the available clothes are overlaid on the screen, and, by tracking the user's hand, he/she is able to pick different outfits by placing the cursor on top of the thumbnail of his/her choice of garment (FIG. 12).

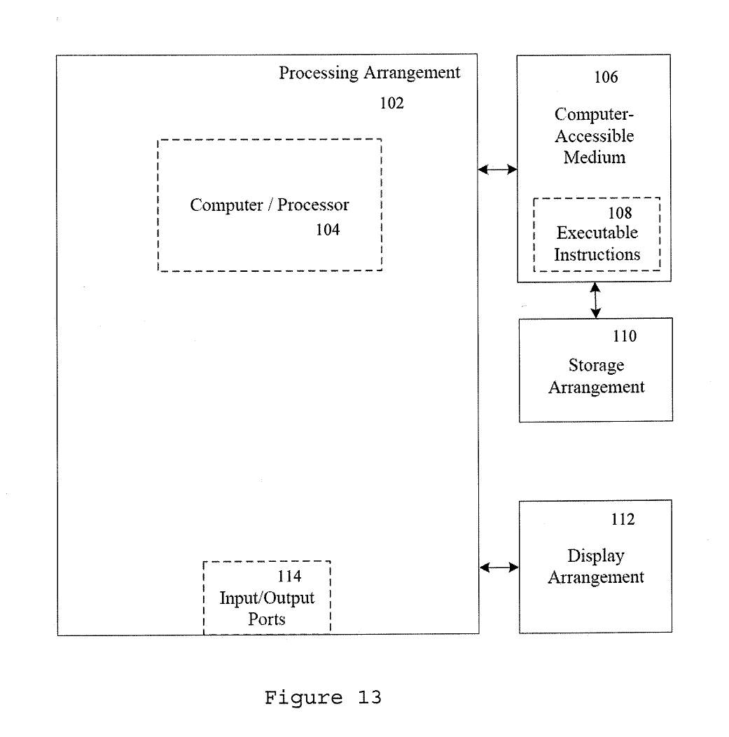

FIG. 13 shows an exemplary block diagram of an exemplary embodiment of a system according to the present disclosure. For example, exemplary procedures in accordance with the present disclosure described herein can be performed by a processing arrangement and/or a computing arrangement 102. Such processing/computing arrangement 102 can be, e.g., entirely or a part of, or include, but not limited to, a computer/processor 104 that can include, e.g., one or more microprocessors, and use instructions stored on a computer-accessible medium (e.g., RAM, ROM, hard drive, or other storage device).

As shown in FIG. 13, e.g., a computer-accessible medium 106 (e.g., as described herein above, a storage device such as a hard disk, floppy disk, memory stick, CD-ROM, RAM, ROM, etc., or a collection thereof) can be provided (e.g., in communication with the processing arrangement 102). The computer-accessible medium 106 can contain executable instructions 108 thereon. In addition or alternatively, a storage arrangement 110 can be provided separately from the computer-accessible medium 106, which can provide the instructions to the processing arrangement 102 so as to configure the processing arrangement to execute certain exemplary procedures, processes and methods, as described herein above, for example.

Further, the exemplary processing arrangement 102 can be provided with or include an input/output arrangement 114, which can include, e.g., a wired network, a wireless network, the interne, an intranet, a data collection probe, a sensor, etc. As shown in FIG. 13, the exemplary processing arrangement 102 can be in communication with an exemplary display arrangement 112, which, according to certain exemplary embodiments of the present disclosure, can be a touch-screen configured for inputting information to the processing arrangement in addition to outputting information from the processing arrangement, for example. Further, the exemplary display 112 and/or a storage arrangement 110 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. In addition, all publications and references referred to above can be incorporated herein by reference in their entireties. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Certain details are set forth of various exemplary embodiments. However, one skilled in the relevant art will recognize that embodiments may be practiced without one or more of these details, or with other methods, components, materials, etc. In other instances, well-known structures associated with controllers, data storage devices and display devices, have not been shown or described in detail to avoid unnecessarily obscuring descriptions of the embodiments.

Unless the context requires otherwise, throughout the specification, the word “comprise” and variations thereof, such as, “comprises” and “comprising” can be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

### EXEMPLARY REFERENCES

The following references are hereby incorporated by reference in their entirety.
1. Arikan, Q., and Forsyth, D. Interactive motion generation from examples. ACM Transactions on Graphics 21(3):483-490, 2002.
2. Brand, M. Voice puppetry. In Proceedings of the 26^{th} annual conference on Computer graphics and interactive techniques, pages 21-28. ACM Press/Addison-Wesley Publishing Co., 1999.
3. Bregler, C., Covell, M., and Slaney, M. Video rewrite: Driving visual speech with audio. In Proceedings of the 24th annual conference on Computer graphics and interactive techniques, pages 353-360. ACM Press/Addison-Wesley Publishing Co., 1997.
4. de Aguiar, E., Stoll, C., Theobalt, C., Ahmed, N., Seidel, H. P., and Thrun, S. Performance capture from sparse multi-view video. In ACM Transactions on Graphics (TOG), volume 27, page 98. ACM, 2008.
5. Dempster, A. P., Laird, N. M., and Rubin, D. B. Maximum likelihood from incomplete data via the em algorithm. Journal of the Royal Statistical Society, Series B, 39(1):1-38, 1977.
6. Deng, Z. and Noh, J. Computer facial animation: A survey. Data-Driven 3D Facial Animation, pages 1-28, 2007.
7. embodee. Embodee's online try-on^{sm} experience. http://hurley.embodee.com/try-on, 2011.
8. Ezzat, Tony, Geiger, Gadi, and Poggio, Tomaso. Trainable videorealistic speech animation. In Proceedings of the 29^{th} annual conference on Computer graphics and interactive techniques, SIGGRAPH '02, pages 388-398, New York, N.Y., USA, 2002. ACM.
9. Flagg, M., Nakazawa, A., Zhang, Q., Kang, S., Ryu, Y. K., Essa, I., and Rehg, J. M. Human video textures. In Proceedings of the 2009 symposium on Interactive 3D graphics and games, pages 199-206. ACM, 2009.
10. Glamour. Glamours virtual dressing room draws readers advertisers. http://www.dmnews.com/glamours-virtual-dressing-room-draws-readers-article/8190_{—}6/, 2002.
11. Goldman, Dan B., Gonterman, Chris, Curless, Brian, Salesin, David, and Seitz, Steven M. Video object annotation, navigation, and composition. In UIST, pages 3-12, 2008.
12. H&M. H & M's virtual dressing room. http://www.hm.com/us/dressingroom, 2007.
13. Huang, P., Hilton, A., and Starck, J. Human motion synthesis from 3d video. In IEEE Int. Conf. on Computer Vision and Pattern Recognition. CVPR, 2009, pages 1478-1485.
14. Jain, Arjun, Thormahlen, Thorsten, Seidel, Hans-Peter, and Theobalt, Christian. Moviereshape: Tracking and reshaping of humans in videos. ACM Trans. Graph. (Proc. SIGGRAPH Asia 2010), 29(5), 2010.
15. Kernelmacher-Shlizerman, Ira, Sankar, Aditya, Shechtman, Eli, and Seitz, Steven M. Being Johnmalkovich. In ECCV (1), pages 341-353, 2010.
16. Kovar, L., Gleicher, M., and Pighin, F. Motion graphs. ACM Transactions on Graphics (TOG) 21(3):473-482, 2002.
17. Lee, J., Chai, J., Reitsma, P. S. A., Hodgins, J. K., and Pollard, N. S. Interactive control of avatars animated with human motion data. ACM Transactions on Graphics, 21(3):491-500, 2002.
18. Levin, Golan and Lieberman, Zachary. Reface [portrait sequencer]. Bitforms gallery, NYC, http://www.flong.com/projects/reface/, 2007.
19. Li, Y., Wang, T., and Shum, H. Y. Motion texture: a two-level statistical model for character motion synthesis. In Proceedings of the 29^{th} annual conference on Computer graphics and interactive techniques, pages 465-472. ACM, 2002.
20. Mori, Masahiro. Bukimi no tani. The uncanny valley (in Japanese). Energy, page 3335, 1970.
21. OPENNI. http://openni.org/.
22. Pullen, Katherine and Bregler, Christoph. Motion capture assisted animation: texturing and synthesis. ACM Transactions on Graphics (SIGGRAPH 2002), 21(3):501-508, 2002.
23. Reinhard, Erik, Ashikhmin, Michael, Gooch, Bruce, and Shirley, Peter. Color transfer between images. IEEE Comput. Graph. Appl., 21(5): 34-41, September 2001.
24. Reverdy, Pierre. Exquisite corpse. http://en.wikipedia.org/wiki/Exquisite_corpse, 1918.
25. Ruderman, D. L., Cronin, T. W., and Chiao, C. C. Statistics of cone responses to natural images: implications for visual coding. Journal of the Optical Society of America A, 15(8):2036-2045, 1998.
26. Schodl, A. and Essa, I. A. Controlled animation of video sprites. In Proceedings of the 2002 ACM SIG-GRAPH/Euro graphics symposium on Computer animation, pages 121-127. ACM, 2002.
27. Seventeen. JC penny augmented reality ‘virtual dressing room’. http://www.seventeen.com/fashion/virtual-dressing-room, 20107.
28. Shotton, Jamie, Fitzgibbon, Andrew, Cook, Mat, Sharp, Toby, Finocchio, Mark, Moore, Richard, Kipman, Alex, and Blake, Andrew. Real-time human pose recognition in parts from a single depth image. Computer Vision and Pattern Recognition, 2011.
29. Stoll, C., Gall, J., de Aguiar, E., Thrun, S., and Theobalt, C. Video-based reconstruction of animatable human characters. In ACM Transactions on Graphics (TOG), volume 29, page 139. ACM, 2010.
30. Viola, P. and Jones, M. Rapid object detection using a boosted cascade of simple features. In Computer Vision and Pattern Recognition, 2001. CVPR 2001. Proceedings of the 2001 IEEE Computer Society Conference on, volume 1, pages 1-511-1-518 void, 2001.
31. Vlasic, D., Brand, M., Pfister, H., and Popovid, J. Face transfer with multilinear models. ACM Transactions on Graphics (TOG), 24(3):426-433, 2005.
32. Weise, Thibaut, Bouaziz, Sofien, Li, Hao, and Pauly, Mark. Realtime performance-based facial animation. ACM Transactions on Graphics (Proceedings SIG-GRAPH 2011), 30(4), July 2011.
33. Xu, Feng, Liu, Yebin, Stoll, Carsten, Tompkin, James, Bharaj, Gaurav, Dai, Qionghai, Seidel, Hans-Peter, Kautz, Jan, and Theobalt, Christian. Video-based characters: creating new human performances from a multi-view video database. ACM Trans. Graph., 30:32:1-32:10, August 2011.
34. Zhou, Shizhe, Fu, Hongbo, Liu, Ligang, Cohen-Or, Daniel, and Han, Xiaoguang. Parametric reshaping of human bodies in images. ACM Trans. Graph., 29:126:1-126:10, July 2010.

What is claimed is:

1. A method for displaying visual information corresponding to at least one user, comprising:
receiving a selection of at least one attribute to be viewed;
with a computer arrangement, tracking at least one user pose of the at least one user in real-time using a marker-less capture procedure to generate tracking information;
matching the at least one user pose with at least one database pose provided in a database based on the tracking information; and
displaying the at least one database pose in combination with the at least one attribute.

2. The method of claim 1, wherein the database includes a plurality of stored images of previously captured skeletal annotated poses obtained using a marker-less capture procedure.

3. The method of claim 2, wherein the previously captured skeletal annotated poses are of at least one person presenting different attributes.

4. The method of claim 3, wherein the different attributes include at least one of clothing or an accessory.

5. The method of claim 3 further comprising analyzing a skin color of the user, and modifying a skin color of the person to match the skin color of the user.

6. The method of claim 1, wherein the at least one attribute includes at least one of clothing or an accessory.

7. The method of claim 1, wherein the at least one database pose approximately matches a position and an orientation of the at least one user pose.

8. The method of claim 3, wherein the clothing is conformed to a body of the at least one user by analyzing a body style of the user.

9. The method of claim 1, wherein the tracking procedure is performed using an image capturing arrangement.

10. The method of claim 2, wherein the marker-less capture procedure is performed using an OpenNI Framework.

11. The method of claim 1, further comprising:
tracking at least one further user pose;
matching the at least one further user pose to at least one further database pose provided in the at least one database; and
displaying the at least one further database pose.

12. The method of claim 11, wherein the matching of the at least one further user pose comprises searching the at least one database for poses that are at least close to the at least one database pose.

13. The method of claim 12, wherein the at least one database is searched using a nearest neighbor procedure.

14. The method of claim 3, wherein the at least one person is different than the at least one user.

15. The method of claim 1, wherein the receiving a selection of at least one attribute to be viewed comprises receiving a selection of three attributes, one attribute corresponding to an upper part of a body, one attribute corresponding to a middle part of a body, and one attribute corresponding to a lower part of a body, and wherein each attribute is displayed in the at least one pose.

16. A computer-accessible medium which includes software thereon for displaying visual information regarding at least one user, wherein, when a computer processing arrangement executes the software, the computer processing arrangement is configured to perform procedures comprising:
receiving a selection of at least one attribute to be viewed;
tracking at least one user pose of the at least one user in real-time using a marker-less capture procedure to generate tracking information;
matching the at least one user pose with at least one database pose provided in a database based on the tracking information; and
displaying the at least one database pose in combination with the at least one attribute.

17. The computer-accessible medium of claim 16, wherein the database includes a plurality of stored images of previously captured skeletal annotated poses obtained using a marker-less capture procedure.

18. The computer-accessible medium of claim 17, wherein the previously captured skeletal annotated poses are of at least one person presenting different attributes.

19. The computer-accessible medium of claim 18, wherein the different attributes include at least one of clothing or an accessory.

20. The computer-accessible medium of claim 18 further comprising analyzing a skin color of the user, and modifying a skin color of the person to match the skin color of the user.

21. The computer-accessible medium of claim 16, wherein the at least one attribute includes at least one of clothing or an accessory.

22. The computer-accessible medium of claim 16, wherein the at least one database pose approximately matches a position and an orientation of the at least one user pose.

23. The computer-accessible medium of claim 17, wherein the clothing is conformed to a body of the at least one user by analyzing the body style of the user.

24. The computer-accessible medium of claim 16, wherein the tracking procedure is performed using an image capturing arrangement.

25. The computer-accessible medium of claim 18, wherein the marker-less capture procedure is performed using an OpenNI Framework.

26. The computer-accessible medium of claim 16, further comprising:
tracking at least one further user pose;
matching the at least one further user pose to at least one further database pose provided in the at least one database; and
displaying the at least one further database pose.

27. The computer-accessible medium of claim 26, wherein the matching of the at least one further poses comprises searching the at least one database for poses that are at least close to the at least one database pose.

28. The computer-accessible medium of claim 27, wherein the at least one database is searched using a nearest neighbor procedure.

29. A system for displaying visual information regarding at least one user, comprising:
a processing hardware arrangement which is configured to:
receive a selection of at least one attribute to be viewed;
track at least one user pose of the at least one user in real-time using a marker-less capture procedure to generate tracking information;
match the at least one user pose with at least one database pose provided in a database based on the tracking information; and
display the at least one database pose in combination with the at least one attribute.
